(19) United States
(12) Patent Application Publication
(10) Pub. No.: US 2026/0257348 A1
(43) Pub. Date: Sep. 3, 2026

(54) CONTROL DEVICE AND CONTROL METHOD

(71) Applicant: Fanuc Corporation, Minamitsuru-gun, Yamanashi (JP)

(72) Inventors: Kiichi TERAMOTO, Minamitsuru-gun, Yamanashi (JP); Shigeo YOSHIDA, Minamitsuru-gun, Yamanashi (JP)

(73) Assignee: Fanuc Corporation, Minamitsuru-gun, Yamanashi (JP)

(21) Appl. No.: 18/875,347

(22) PCT Filed: Jul. 7, 2022
(86) PCT No.: PCT/JP2022/027033

§ 371 Date: Dec. 16, 2024

(51) Int. Cl. B25J 9/16

(52) U.S. Cl. CPC B25J 9/163

(57) ABSTRACT

Provided are a control device and a control method that make it possible to greatly simplify the work of a user in creating a search program for generating teaching points. The control device includes: a teaching unit that teaches the search start position and search end position of a work line by means of a sensor; a program generation unit that generates a search program for determining a teaching point corresponding to a position on the work line on the basis of the search start position and the search end position, and generates a work program including a teaching point on the basis of the result of executing the search program; and a specification unit configured to specify, at the time of generating the search program, whether to execute tracking with the sensor for correcting the position of the robot during the execution of the work program.

### CROSS REFERENCE TO RELATED APPLICATIONS

This is the U.S. National Phase application of PCT/JP2022/027033, filed Jul. 7, 2022, the disclosures of this application being incorporated herein by reference in their entireties for all purposes.

### FIELD OF THE INVENTION

The present invention relates to a controller and a control method.

### BACKGROUND OF THE INVENTION

A robot system including a robot, a work tool such as a welding torch attached to the robot, and a controller for controlling the robot is well known. The controller drives the robot and the work tool based on an operation program, and a user of the robot can teach teaching points in advance to determine the position and posture of the robot during an operation. The operation program is generated based on the positions of the teaching points.

The location of the teaching point can have a significant effect on the quality of the operation performed by the robot. For example, in a robot system for performing arc welding, the robot moves a welding torch attached to a robot arm, etc., along an operation path determined based on the teaching points. When the operation path deviates from a desired path, a welding line also deviates therefrom, resulting in a decrease in processing accuracy.

In order to correct such a deviation in the operation path, a control method is known in which a sensor is provided to a work tool such as a welding torch, and the operation path is corrected while performing an operation such as welding. For example, a control method is known in which an operation path is previously generated by specifying start and end points, and then, while the position of the robot is moved along the operation path, the position where the welding is to be performed detected by the sensor is set as a teaching point (e.g., see Patent Literature 1).

Also, a teaching device, intended to simplify teaching of operation of a laser scanner and shorten a welding time of a robot, is well known (e.g., see Patent Literature 2).

Further, a robot, configured to perform an operation such as welding by detecting the position of a weld line using a laser sensor intended to optimize a movement path of an end effector of the robot by tracking, and then move a work tool along the detected line, is well known (e.g., see Patent Literature 3).

### PATENT LITERATURE

[PTL 1] JP 1995(H07)-104831 A
[PTL 2] JP 2006-247677 A
[PTL 3] JP 2004-160578 A

### SUMMARY OF THE INVENTION

In order to effectively suppress the positional deviation of the operation path of the robot, it is desirable to accurately generate and set the teaching point. For example, the teaching point can be set by the operator manually moving the robot to a desired position and posture, but the teaching point often requires high accuracy of 1 mm or less. Therefore, the operator needs to have a high skill level, and even for experienced operators, considerable work time may be required.

One way to generate a teaching point is to set a search point to determine the next teaching point along the operation path based on a certain teaching point. In this way, it is possible to generate an accurate operation program for a given workpiece. However, when trying to execute the same operation program on different workpieces in a production line, etc., a dimensional error or misalignment of the location of each workpiece cannot be accommodated, making it difficult to perform a specified operation such as welding with high precision.

One approach to address the above problem is to create an operation program for each workpiece, but this requires the robot to operate twice for each workpiece, extending the cycle time and ultimately reducing productivity.

One aspect of the present disclosure provides a controller configured to control a robot having a sensor capable of detecting an operation line of a workpiece, the controller comprising: a teaching unit configured to teach a search start position and a search end position of the operation line by means of the sensor; a program generation unit configured to generate a search program for determining a teaching point corresponding to a position on the operation line based on the search start position and the search end position, and generate an operation program including the teaching point based on a result of executing the search program; and a designation unit configured to designate, when the search program is generated, whether or not to execute tracking using the sensor for correcting the position of the robot during the execution of the operation program.

Another aspect of the present disclosure provides a control method for controlling a robot having a sensor capable of detecting an operation line of a workpiece, the control method comprising the steps of: teaching a search start position and a search end position of the operation line by means of the sensor; generating a search program for determining a teaching point corresponding to a position on the operation line based on the search start position and the search end position; generating an operation program including the teaching point based on a result of executing the search program; and designating, when the search program is generated, whether or not to execute tracking using the sensor for correcting the position of the robot during the execution of the operation program.

### BRIEF DESCRIPTION OF DRAWINGS

FIG. 1 is a schematic configuration view of a robot system according to an embodiment.

FIG. 2 is a view explaining teaching of search start and end positions using a sensor.

FIG. 3 is a view showing an example in which the search start point is taught by using a user interface.

FIG. 4 is a view showing an example in which the search end point is taught by using the user interface.

FIG. 5 is a view explaining that a program is corrected by tracking.

FIG. 6 is a view explaining an example in which an amount of offset is determined in teaching the search start and end positions.

FIG. 7 is a view showing an example of the user interface for setting various conditions in generating the search program.

FIG. 8 is a view showing an example in which an operation program is automatically generated by using the user interface.

FIG. 9 is a flowchart showing an example of a process with respect to program generation.

### DETAILED DESCRIPTION OF EMBODIMENTS OF THE INVENTION

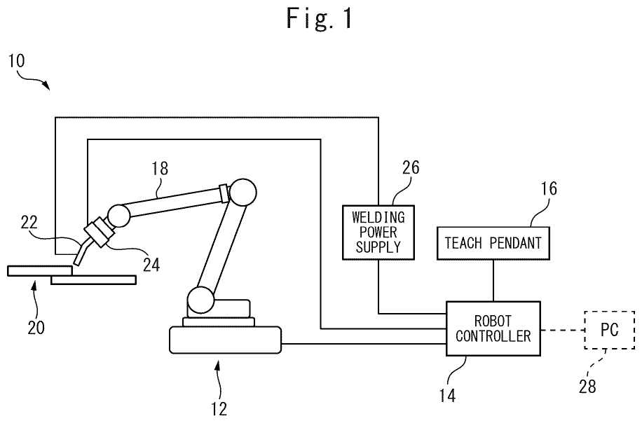

FIG. 1 is a schematic configuration view of a robot system according to a preferred embodiment. The robot system 10 includes at least one robot 12, a robot controller 14 configured to control the robot 12, and a teach pendant 16 communicably connected to the robot controller 14 by wireless or wire.

The robot 12 is, for example, an industrial articulated robot, and has a movable part (robot arm) 18, a work tool 22 attached to a front end of the movable part 18 and configured to perform a predetermined operation on an object (workpiece) 20, and a sensor 24 capable of detecting a position of a work site (e.g., an operation line) on the workpiece 20 by the work tool 22. In this embodiment, the work tool 22 is a welding torch, and accordingly, the robot system 10 includes a welding power supply 26 for supplying current to the welding torch 22 based on a command from the robot controller 14. As described above, in this embodiment, the operation line includes the welding part of the workpiece, although the present disclosure is not limited as such. For example, the predetermined operation to be performed by the robot may be sealing, the operation line may include a sealing part of the workpiece, and the working tool 22 may be a nozzle for dispensing adhesive.

In the embodiment, the sensor 24 is a laser scanner type 3D sensor (laser sensor) having an emission unit configured to emit light (e.g., laser beam) based on a command from the robot controller 14, and an image sensor (CCD, CMOS, etc.) configured to receive the light reflected by the workpiece and convert it to electricity. The sensor 24 is attached to the front end of the movable part 18 or the welding torch 22 using an appropriate fixture (not shown), and can search the operation line by continuously scanning the workpiece along the operation line. However, the sensor is not limited to a laser sensor, and any sensor capable of detecting the operation line can be used. For example, a 3D sensor can also be used. Examples of the 3D sensor may include a TOF (Time of Flight) camera configured to capture a distance image using a time-of-flight method, or a stereo camera configured to detect a 3D position based on a parallax captured by two 2D cameras, etc.

The robot 12 is configured to be able to perform various processes and/or operations such as welding based on a command transmitted from the robot controller 14. The robot controller 14 includes a processor and a storage unit (memory, etc.), and can control the robot 12 based on an operation program described below. In addition to the operation program for controlling the robot 12, the robot controller 14 can generate and save a search program, which will be described later, and execute it to control the sensor 24. In other words, in this embodiment, the teach pendant 16 has a function of a teaching unit, the processor of the robot controller 14 has a function of a program generation unit, and a user interface described below has a function of a designation unit. However, the present disclosure is not limited as such, for example, a computer such as a personal computer (PC) 28 connected to the controller 14 by wire or wirelessly and having a processor and a storage unit (memory, etc.) may generate each program, so that the generated programs can be transmitted from the PC 28 to the controller 14.

The teach pendant 16 may include a reception unit such as a keyboard or a touch panel capable of receiving various inputs from the user, and a display unit such as a display. The reception unit and the display unit may constitute a user interface.

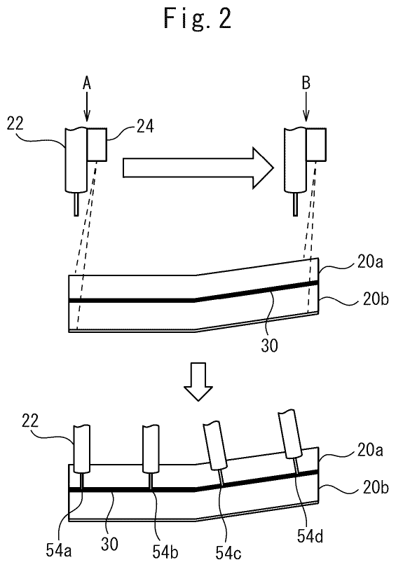

FIG. 2 is a view schematically illustrating welding as an example of an operation performed by the robot 12. In this regard, the shapes of two plate-shaped workpieces 20a and 20b are measured using the laser sensor 24 attached to the welding torch 22, and teaching points are automatically generated based on information obtained from the sensor 24. Then, arc welding is performed along a welding line 30.

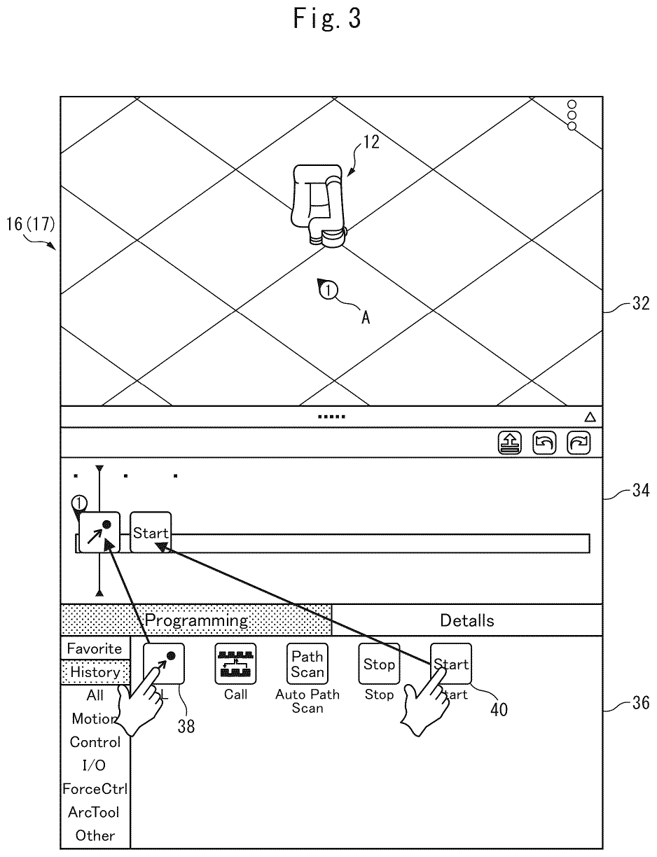

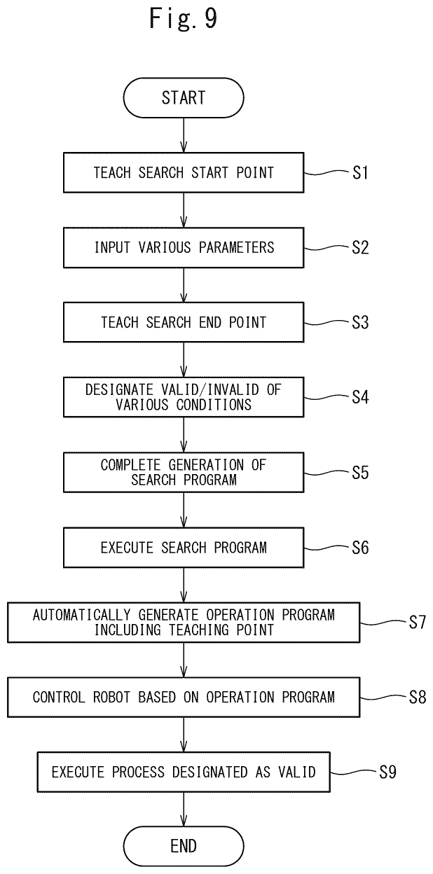

Hereinafter, means and procedures for generating a search program and an operation program will be described with reference to FIGS. 3 to 9. As exemplified in FUG. 3, a user or operator of the robot 12 (hereinafter simply referred to as the user), can input various information for generating the search program and the operation program as described later, via a user interface (UI) 17 displayed on the display of the teach pendant 16, etc. In other words, the UI 17 has the functions of the display unit which allows the user to visually recognize various information, and the reception unit which receives various inputs from the user. The UI 17 includes a robot display area 32 capable of displaying a robot image corresponding to the position and posture of the actual robot 12, a timeline display area 34 capable of displaying icons (described later) arranged in chronological order, and a menu area 36 capable of displaying each icon so that the user can select a desired icon.

First, in step S1, the user of the robot 12 teaches a search start position (search start point) for the robot 12. Specifically, the user moves the robot 12 so that the sensor 24 is positioned at a search start point A (see FIG. 2) where the sensor 24 can detect the welding start position or its vicinity. Here, as shown in FIG. 3, in the robot display area 32, an image corresponding to the position and posture of the actual robot 12 moved by the user can be displayed. After confirming that the robot 12 is positioned at the search start point A, the user selects an icon 38 (L) representing the search point from the menu display area 36, and moves the selected icon to the timeline display area 34 by an operation such as drag and drop. Then, the icon “L” is placed at the left end of the timeline display area 34, which means that the search start position has been taught.

It should be noted that the search start position is different from the welding start position (operation start position). For example, in direct teaching, it may be difficult to teach the welding start position due to interference between the robot and the workpiece. In such a case, the teaching can be facilitated by using the search start position which is some distance from the welding start position. However, when there are no restrictions such as interference, the search start position and the welding start position may end up being the same position. Similarly, the search end position is different from the welding end position (operation end position), but may end up being the same position.

Next, the user selects an icon 40 (Start) representing a search start command from the menu display area 36, and moves the selected icon to the timeline display area 34 by an operation such as drag and drop. Then, the icon “Start” is placed to the right of the icon “L” in the timeline display area 34.

By the search start command, the user can set various parameters in the search program (step S2). For example, the search program may include at least one of information relating to a search range of the sensor 24, information relating to an output of the sensor 24, information relating to a path of the sensor 24, and information relating to the automatically generated operation program. For example, the user can input information relating to a change in posture between each teaching point, as the information relating to the path of the sensor 24. Also, the user can input information relating to the automatically generated operation program, e.g., can designate a welding speed in the operation program.

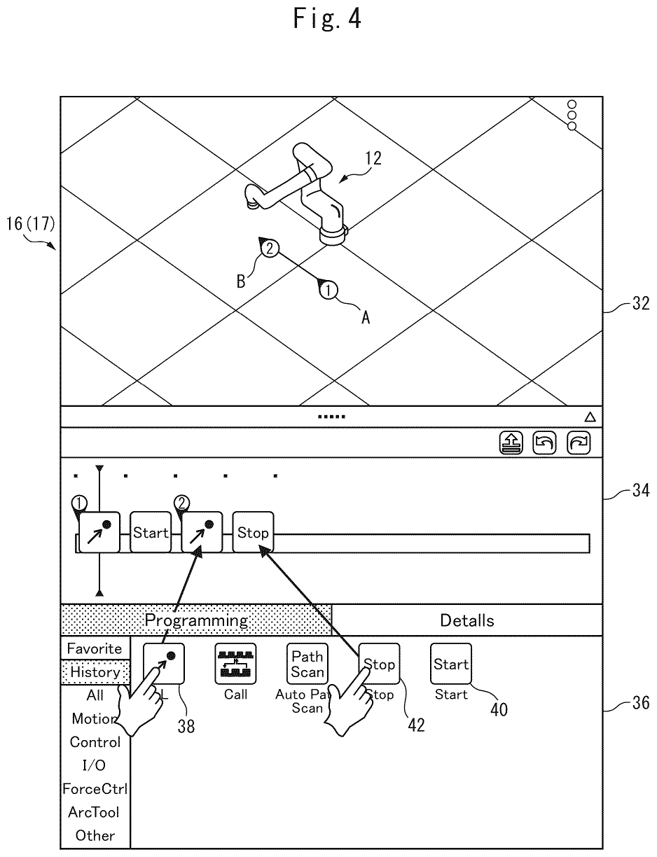

Next, as shown in FIG. 4, the user teaches the search end position (search end point) for the robot 12 (step S3). Specifically, the user moves the robot 12 so that the sensor 24 is positioned at a search end point B (see FIG. 2) where the sensor 24 can detect the welding end position or its vicinity. Here, the robot display area 32 displays the state of the actual robot 12 moved by the user. After confirming that the robot 12 is positioned at the search end point B, the user selects the icon 38 (L) representing the teaching point from the menu display area 36 and moves the selected icon to the timeline display area 34 by the operation such as drag and drop. Then, an icon “L” is placed to the right of the icon “Start” in the timeline display area 34, which means that the search end position has been taught.

Next, the user selects an icon 42 (Stop) representing that the search has been completed from the menu display area 36, and moves it to the timeline display area 34 by the operation such as drag and drop. Then, an icon “Stop” is placed at the right end of the timeline display area 34.

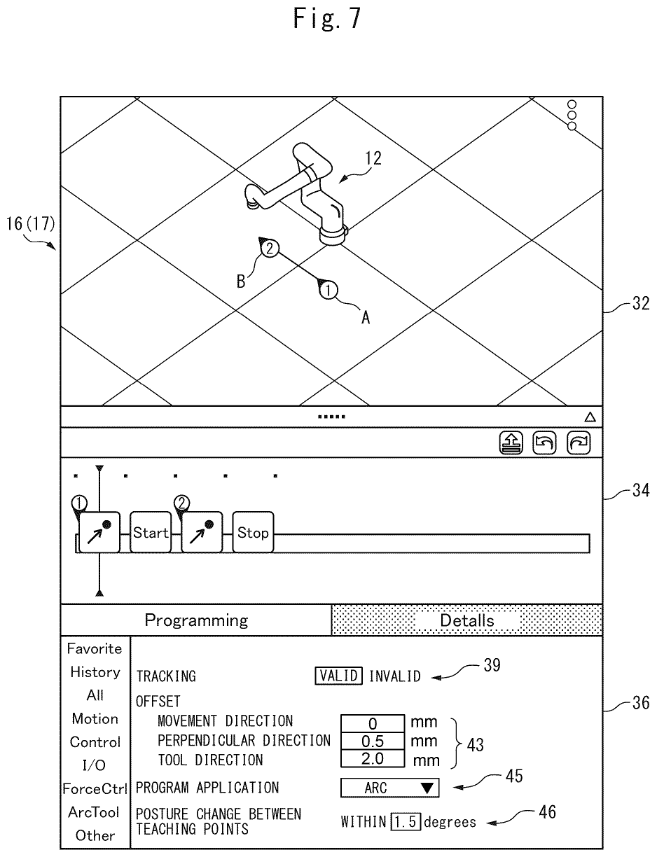

In this case, the user can set whether or not to execute a predetermined process when executing the operation program described below (step S4). For example, as shown in FIG. 7, when the user switches the menu display area 36 from “Programming” to “Details”, a setting screen for the search program is displayed, and then the user can designate (input) whether various conditions are valid or invalid. Examples of the above-mentioned predetermined process may include tracking, setting of an offset amount, and posture change between the teaching points. These processes are described in detail hereinafter.

As indicated by reference numeral 39 in FIG. 7, the user can set whether or not to perform tracking by the sensor 24 during execution of the operation program for a workpiece (e.g., workpieces 20c and 20d) different from that during execution of the search program. When the setting is set to “valid”, the tracking of the workpiece by the sensor 24 is performed during execution of the operation program, and a motion correction unit corrects the motion of the robot based on a result of the tracking.

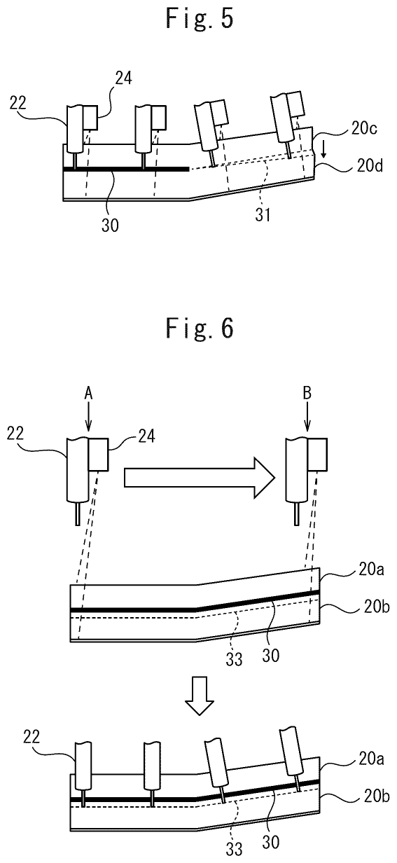

FIG. 5 is a view illustrating the operation of the tool 22 in case that the tracking is set to be performed when the operation program is executed. As shown in FIG. 2, when the search program is executed for the workpieces 20a and 20b to generate the operation program, there is basically no need to perform tracking when using this operation program is used for the operation (welding, etc.) on the workpieces 20a and 20b. However, when the same operation program is performed on different workpieces 20c and 20d, even if the workpieces 20c and 20d have the same specifications as the workpieces 20a and 20b, there is a possibility that accurate operation cannot be performed due to a dimensional error, an installation error, and thermal deformation, etc. In this regard, when the tracking is set to be performed when the operation program is executed, the motion path of the robot is corrected by the tracking according to the position and a dimensional error of the workpiece, making it possible to perform the operation with high accuracy. In addition, since the tracking only corrects the operation program, it is sufficient to generate the operation program itself once at the start of production, etc. Therefore, the tracking has almost no effect on the productivity of the entire system including the robot.

As indicated by reference numeral 43 in FIG. 7, the user can set a condition relating to an offset from the operation line 30 during the tracking. For example, the user can set which direction (the moving direction, the direction perpendicular to the moving direction, or the direction in which the tool itself extends, etc.) of the tool 22 is to be set as the amount of offset during the tracking. In case that the setting relating to the offset is done, as exemplified in FIG. 6, when the operation program is executed for the workpieces 20a and 20b, the tool 22 moves along an offset operation line 33 which is offset from the operation line 30 by the set amount of offset. For example, in arc welding, there are cases where higher quality welding can be performed by making the tool follow a line which is somewhat offset from the operation line, rather than making the tool follow the operation line itself. In such a case, such a function of offsetting the operation line is very useful.

As indicated by reference numeral 45 in FIG. 7, the user can select and designate the application of the operation program to be generated. For example, when the user selects “arc”, the “welding start command” and “welding end command” are automatically taught in the operation program, improving user convenience. On the other hand, when no command is designated, the operation program will only contain an operation statement for the robot.

As indicated by reference numeral 46 in FIG. 7, the user can set a condition relating to the change in the posture of the tool. For example, when the above-mentioned tracking only corrects the position of the tool (i.e., the posture of the tool is not corrected), it may be difficult to ensure the accuracy of the posture. In such a case, it is effective to use an operation program which reduces the distance between teaching points in a section where the posture change of the tool is relatively large, and increases the distance between teaching points in a section where the posture change is relatively small. Therefore, as shown in FIG. 7, the user can easily genera the above-mentioned operation program by setting an upper limit of the posture change between teaching points.

After the processes of S1 to S4 are completed, the robot controller 14 or the PC 28, which corresponds to the program generation unit, completes the generation of the search program for performing the search using the sensor 24 (step S5). In other words, the search program can be displayed as a series of icons arranged and displayed in chronological order within the timeline display area 34. In this way, the user can generate the search program through visually and intuitively easy-to-understand operations via the teach pendant (UI). Therefore, even when the user is not an expert, he or she can generate the desired search program in a short time with simple operations. In this embodiment, the user teaches the search start point and search end point by directly moving the robot with his or her hand (so-called direct teaching). However, the present disclosure is not limited as such, for example, the user may move the robot by jog operation. In addition, the setting of various conditions in step S4 is performed before executing the search program.

Further, in the search program, the user can add not only the search start point and the search end point, but also any arbitrary point. For example, for the purpose of changing the movement direction of the torch during laser irradiation, at least one intermediate point can be taught between the search start point and the search end point. Further, the operation mode of the torch is not limited to a straight line, and the torch can be moved along an arc, for example. Information relating to these intermediate points can also be displayed as icons.

Next, the search program generated in step S5 is executed (step S6). Here, the scanning laser is irradiated from the sensor 24 toward the workpiece in a section from the search start position to the search end position, and at least one teaching point is generated in the same section. By virtue of this, an operation program including the teaching point is automatically generated (step S7). The search program can also be executed by the user through the UI 17.

In the search operation, as shown in FIG. 2, while the sensor 24 moves from the search start position A to the search end position B, the shapes of the workpieces 20a and 20b are detected, and the teaching point of the robot 12 is automatically generated based on the result of detection. In this example, since the workpiece has a bent portion near the center, a laser irradiation start point 54a corresponding to the starting end of the welding line 30, a laser irradiation end point 54d corresponding to the terminal end of the welding line 30, and intermediate teaching points 54b and 54c near the center are generated.

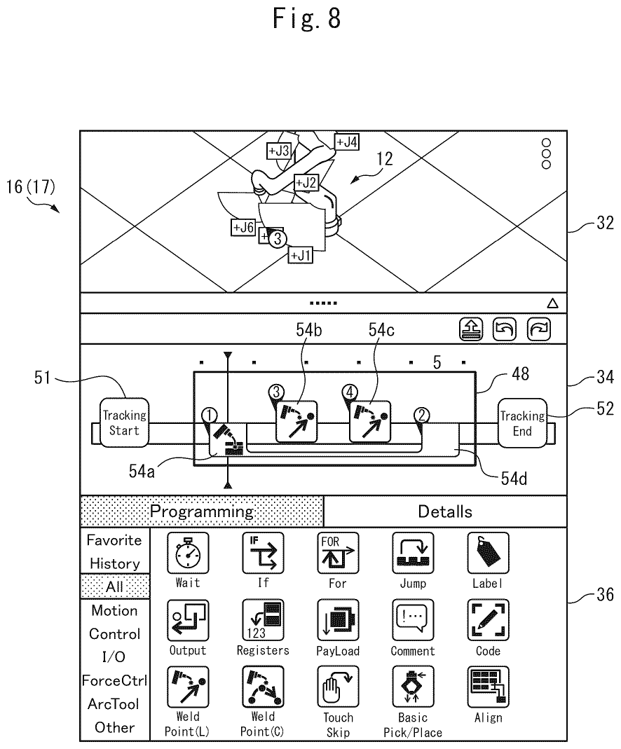

After the search is completed and the teaching points are generated, the operation program including the generated teaching points is automatically generated. For example, as shown in FIG. 8, the operation program is displayed in the timeline display area 34 as a combination of icons 48. In this regard, the operation program 48 includes an icon 54a representing the start of welding, an icon 54d representing the end of welding, and icons 54b and 54c representing each teaching point in the welding operation between the icons 54a and 54d. These icons are displayed in chronological order within the timeline display area 34. In the example of FIG. 8, although all of the icons 54a to 54d are displayed, at least one of the icon 54a including information relating to the search start position, the icon 54d including information relating to the search end position, and the icons 54b and 54c including information relating to the intermediate points between the search start position and the search end position, may be displayed.

The user can check and edit the automatically generated operation program through the UI 17 of the teach pendant 16. For example, by clicking any of the icons 54a to 54d in the timeline display area 34, various icons including operational information etc., are displayed in the menu display area 36. Then, the user can set or change various parameters in the operation program, e.g., can correct the position of the teaching point, etc.

The UI 17 also reflects settings such as whether or not to perform the above-mentioned tracking. In the example of FIG. 8, a command to start the tracking and a command to terminate the tracking are displayed as icons 51 and 52, respectively. These icons can also be displayed in the timeline format together with the above-mentioned icons 54a to 54d, by which the user can understand them very easily.

After the generation (and editing as necessary) of the operation program is completed, the robot is controlled based on the operation program (step S8). Here, since the process such as the tracking which was set to be valid in step S4 is included as a command in the operation program, the process is also executed (step S9). By virtue of this, the robot can perform a predetermined operation such as welding based on the automatically generated operation program.

According to the above-described examples, the operations of the user such as the teaching in generating the search program for generating the teaching point is significantly simplified by visual operation/input via the UI. Therefore, even an inexperienced user can generate a desired search program in a short time with simple operations, and furthermore, by executing the search program, appropriate teaching points (or an operation program) can be automatically generated.

### REFERENCE SIGNS LIST

10 robot system
12 robot
14 robot controller
16 teach pendant
17 user interface
18 robot arm
20 workpiece
22 welding torch
24 sensor
26 welding power supply
28 PC
30 operation line
32 robot display area
33 offset operation line
34 timeline display area
36 menu display area
38, 40, 42, 51, 52 icon
48 operation program
54a to 54d teaching point

1. A controller configured to control a robot having a sensor capable of detecting an operation line of a workpiece, the controller comprising:
a teaching unit configured to teach a search start position and a search end position of the operation line by means of the sensor;
a program generation unit configured to generate a search program for determining a teaching point corresponding to a position on the operation line based on the search start position and the search end position, and generate an operation program including the teaching point based on a result of executing the search program; and
a designation unit configured to designate, when the search program is generated, whether or not to execute tracking using the sensor for correcting the position of the robot during the execution of the operation program.

2. The controller according to claim 1, wherein the designation unit is configured to be able to designate an amount of offset for offsetting the operation line when the operation program is generated.

3. The controller according to claim 1, wherein the designation unit is configured to be able to designate an application of the operation program when the operation program is generated.

4. The controller according to claim 1, wherein the designation unit is configured to be able to designate a condition with respect to a change in a posture of the robot when the operation program is generated.

5. A control method for controlling a robot having a sensor capable of detecting an operation line of a workpiece, the control method comprising the steps of:
teaching a search start position and a search end position of the operation line by means of the sensor;
generating a search program for determining a teaching point corresponding to a position on the operation line based on the search start position and the search end position;
generating an operation program including the teaching point based on a result of executing the search program; and
designating, when the search program is generated, whether or not to execute tracking using the sensor for correcting the position of the robot during the execution of the operation program.
